(19) United States
(12) Patent Application Publication
(10) Pub. No.: US 2026/0219386 A1
(43) Pub. Date: Jul. 30, 2026

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventors: Kosuke KINOSHITA, Tokyo (JP); Yukihiro YANO, Tokyo (JP); Takahiro KUMURA, Tokyo (JP)

(73) Assignee: NEC Corporation, Tokyo (JP)

(21) Appl. No.: 19/444,524

(22) Filed: Jan. 9, 2026

(30) Foreign Application Priority Data
Jan. 30, 2025 (JP) 2025-014287

(51) Int. Cl. G01S 13/90

(52) U.S. Cl. CPC G01S 13/9021

(57) ABSTRACT

An information processing apparatus includes a data acquisition unit that acquires time-series observation data for each measurement point of an object, the time-series observation data being generated by emission of radio waves from a flying object to the object, and a calculation processing unit that selects a specific measurement point by using temporal coherence used for estimation of a parameter for modeling the observation data for each measurement point, and calculates the parameter and a residual phase component of an unselected measurement point by using the parameter and the residual phase component generated at the time of the modeling at the selected specific measurement point.

This application is based upon and claims the benefit of priority from Japanese patent application No. 2025-014287, filed on Jan. 30, 2025, the disclosure of which is incorporated herein in its entirety by reference.

### TECHNICAL FIELD

The present disclosure relates to an information processing apparatus and an information processing method for performing displacement analysis in a structure, and further relates to a program for achieving the information processing apparatus and the information processing method.

### BACKGROUND ART

In recent years, displacement analysis using a satellite synthetic aperture radar (SAR) has been performed on an infrastructure such as a bridge (for example, see Oriol Monserrat, Michele Crosetto, Maria Cuevas, and Bruno Crippa, “The Thermal Expansion Component of Persistent Scatterer Interferometry Observations”, IEEE Geosci. and Remote Sens. Lett., 8, 5, pp. 864-868, 2011). In displacement analysis of a bridge using the satellite SAR, radio waves are emitted from a satellite toward the bridge at a set interval. The radio waves are then reflected at a plurality of measurement points on the bridge, and reflected waves are received. A phase difference between the reflected waves is then calculated in time series for each measurement point by interference processing. This phase difference is caused by displacement generated on the bridge during the emission interval of the radio waves. The time-series phase difference calculated for each measurement point is then converted into displacement for each measurement point by using a wavelength of the radio waves.

Meanwhile, it is not necessarily possible to accurately calculate the displacement at all the measurement points. This is because data of the phase difference calculated in time series (hereinafter, “time-series phase difference data”) includes a nonlinear displacement component and a noise component of an object, and these components are different for each measurement point. Therefore, a residual phase component is obtained from the time-series phase difference data for each measurement point, and temporal coherence (TPC) is further obtained using the residual phase component.

The temporal coherence is an index representing smallness of dispersion of the residual phase component in the entire time-series phase difference data. The temporal coherence takes a value within a range of 0 to 1, and the closer to 1, the smaller the dispersion of the residual phase component. Therefore, the displacement is calculated using only measurement points at which the value of the temporal coherence is equal to or more than a set value.

### SUMMARY

However, since it is better as the number of available measurement points increases in order to accurately measure the displacement of the bridge or the like, when all measurement points at which values of the temporal coherence are less than the set value are made unavailable, it is difficult to improve measurement accuracy of the displacement.

An example of an object of the present disclosure is to increase the number of available measurement points in a case where displacement analysis of a structure is performed by emission of radio waves from above.

In order to achieve the above object, an information processing apparatus in an aspect of the present disclosure includes
a data acquisition unit that acquires time-series observation data for each measurement point of an object, the time-series observation data being generated by emission of radio waves from a flying object to the object, and
a calculation processing unit that selects a specific measurement point by using temporal coherence used for estimation of a parameter for modeling the observation data for each measurement point, and calculates the parameter and a residual phase component of an unselected measurement point by using the parameter and the residual phase component generated at the time of the modeling at the selected specific measurement point.

In order to achieve the above object, an information processing method in an aspect of the present disclosure includes
a data acquisition step of acquiring time-series observation data for each measurement point of an object, the time-series observation data being generated by emission of radio waves from a flying object to the object, and
a calculation processing step of selecting a specific measurement point by using temporal coherence used for estimation of a parameter for modeling the observation data for each measurement point, and calculating the parameter and a residual phase component of an unselected measurement point by using the parameter and the residual phase component generated at the time of the modeling at the selected specific measurement point.

In order to achieve the above object, a computer-readable recording medium in an aspect of the present disclosure records a program including a command for causing a computer to execute
a data acquisition step of acquiring time-series observation data for each measurement point of an object, the time-series observation data being generated by emission of radio waves from a flying object to the object, and
a calculation processing step of selecting a specific measurement point by using temporal coherence used for estimation of a parameter for modeling the observation data for each measurement point, and calculating the parameter and a residual phase component of an unselected measurement point by using the parameter and the residual phase component generated at the time of the modeling at the selected specific measurement point.

As described above, according to the present disclosure, it is possible to increase the number of available measurement points in a case where displacement analysis of a structure is performed by emission of radio waves from above.

### BRIEF DESCRIPTION OF THE DRAWINGS

FIG. 1 is a configuration diagram illustrating a schematic configuration of an example of an information processing apparatus;

FIG. 2 is a configuration diagram more specifically illustrating a configuration of an example of the information processing apparatus;

FIG. 3 is a diagram schematically illustrating a reflection point at which time-series observation data is generated and an object;

FIG. 4 is a diagram illustrating an example of output by the information processing apparatus;

FIG. 5 is a flowchart illustrating an example of operation of the information processing apparatus;

FIG. 6 is a diagram illustrating a parameter for each measurement point;

FIG. 7 is a diagram illustrating a relationship between a value of temporal coherence and a residual phase component; and

FIG. 8 is a block diagram illustrating an example of a computer that achieves the information processing apparatus.

### EXAMPLE EMBODIMENT

### Example Embodiment

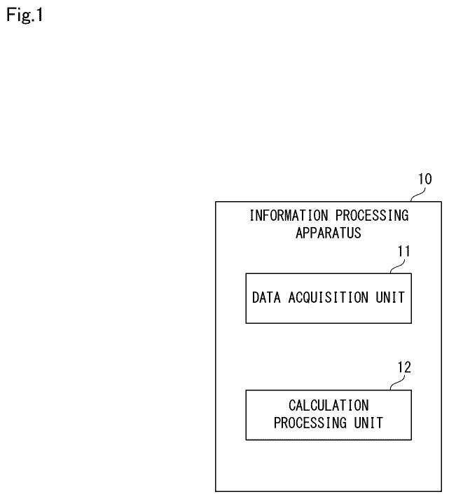

Hereinafter, in an example embodiment, examples of an information processing apparatus, an information processing method, and a program will be described with reference to FIGS. 1 to 8.

### [Apparatus Configuration]

First, a schematic configuration of the information processing apparatus will be described with reference to FIG. 1. FIG. 1 is a configuration diagram illustrating a schematic configuration of an example of the information processing apparatus.

An information processing apparatus 10 illustrated in FIG. 1 is an apparatus used for displacement analysis in a structure. As illustrated in FIG. 1, the information processing apparatus includes a data acquisition unit 11 and a calculation processing unit 12.

The data acquisition unit 11 acquires time-series observation data for each measurement point of an object, which is generated by emission of radio waves from a flying object to the object. The calculation processing unit 12 selects a specific measurement point by using temporal coherence used for estimation of a parameter for modeling the observation data for each measurement point. The calculation processing unit 12 further calculates a parameter and a residual phase component of an unselected measurement point by using a parameter and a residual phase component generated at the time of modeling at the selected specific measurement point.

In this manner, the information processing apparatus 10 calculates parameters and residual phase components at the other measurement points by using parameters and residual phase components at measurement points at which a value of the temporal coherence is equal to or more than a set value. That is, according to the information processing apparatus 10, it is possible to re-calculate the parameters and the residual phase components of the measurement points that cannot be used for the displacement analysis to appropriate values. Therefore, even the measurement points that cannot be originally used for the displacement analysis can be used for the displacement analysis. According to the information processing apparatus 10, it is possible to increase the number of available measurement points in a case where the displacement analysis of the structure is performed by the emission of the radio waves from above.

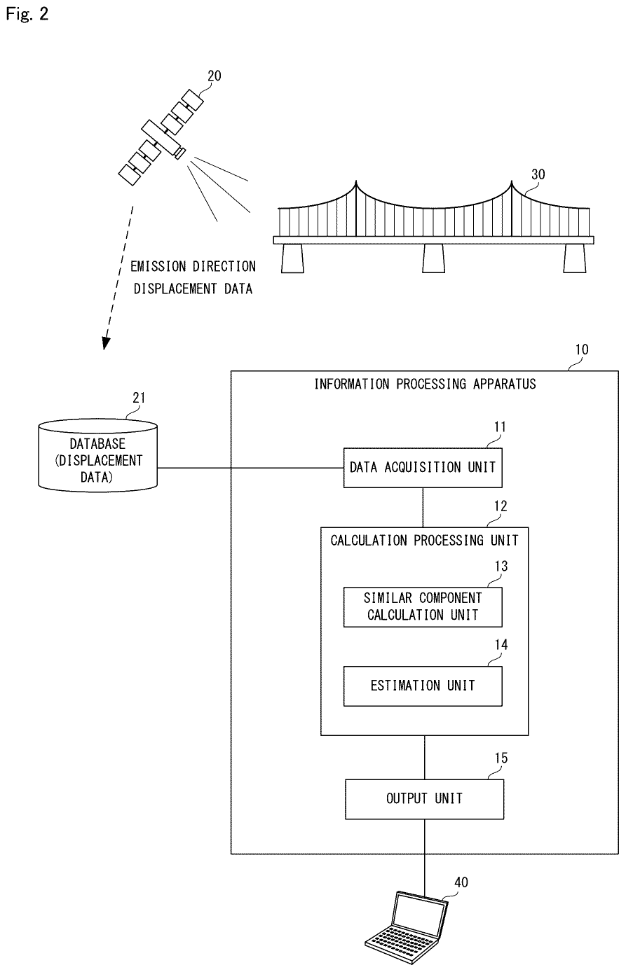

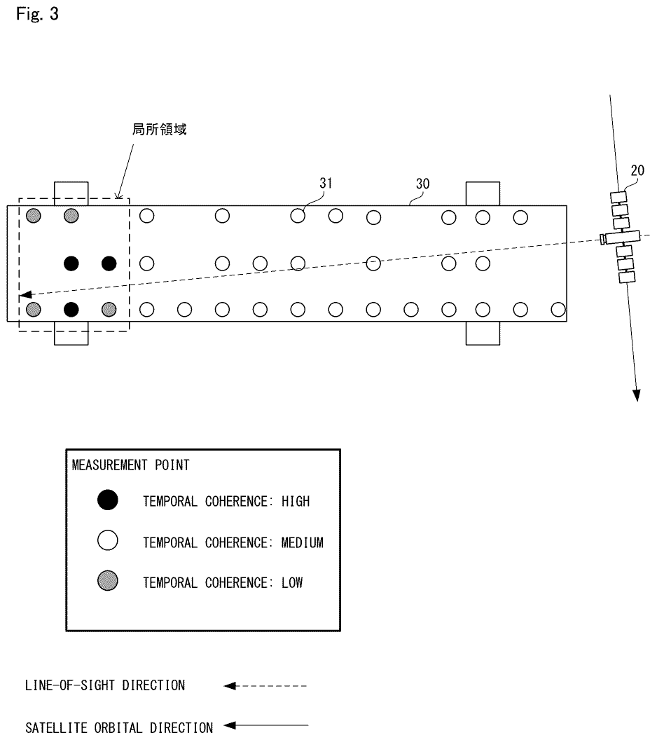

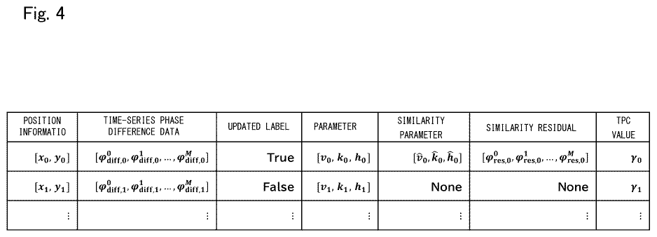

Subsequently, a configuration and a function of an example of the information processing apparatus 10 will be described in more detail with reference to FIGS. 2 to 4. FIG. 2 is a configuration diagram more specifically illustrating a configuration of an example of the information processing apparatus. FIG. 3 is a diagram schematically illustrating a reflection point at which the time-series observation data is generated and the object. FIG. 4 is a diagram illustrating an example of output by the information processing apparatus.

As illustrated in FIG. 2, the information processing apparatus 10 includes an output unit 15 in addition to the data acquisition unit 11 and the calculation processing unit 12 described above. In the information processing apparatus 10, the calculation processing unit 12 includes a similar component calculation unit 13 and an estimation unit 14.

In the example embodiment, as illustrated in FIG. 2, the flying object is an artificial satellite 20, and the object is an infrastructure, for example, a bridge 30. Therefore, the time-series observation data for each measurement point of the object is data of a phase difference (time-series phase difference data) calculated in time series for each measurement point on the bridge. As illustrated in FIG. 3, a plurality of measurement points 31 exists along a bridge axis direction and a width direction (direction perpendicular to a bridge axis) of the bridge 30. In FIG. 3, a broken arrow indicates an emission direction of the radio waves from the artificial satellite 20, and a solid arrow indicates an orbit of the artificial satellite 20.

As illustrated in FIG. 2, the artificial satellite 20 transmits the time-series phase difference data for each measurement point to a base (not illustrated in FIG. 2) at a set date and time or periodically. The time-series phase difference data for each measurement point received at the base is accumulated in a database 21.

In the example embodiment, the data acquisition unit 11 acquires, from the database 21, the time-series phase difference data at each measurement point 31 of the bridge 30 as the time-series observation data for each measurement point. Here, assuming that the phase difference at each measurement point 31 is φ^{m}_{diff}, the phase difference φ^{m}_{diff} can be modeled by the following Expression 1.

$${φ}_{diff}^{m} = \frac{4 π}{λ} Δ {t}^{m} v + \frac{4 π}{λ} Δ {T}^{m} k + \frac{4 π}{λ} \frac{{B}_{⊥}^{m}}{R sin θ} h + {φ}_{res}^{m} \qquad [ Expression 1 ]$$

In Expression 1 above, v, k, and h are unknown parameters. Time-proportional displacement (displacement per year [mm/year]) in the bridge 30 is indicated by v. Temperature-proportional displacement (displacement per temperature of 1° C. [mm/° C.]) in the bridge 30 is indicated by k. A noise phase component derived from a height of the bridge 30 is indicated by h. The other parameters are known, and are given as the following Expression 2.

$$λ : wavelength of radio waves \qquad [ Expression 2 ]$$

$$θ : incident angle of radio waves$$

$$R : slant range$$

$$m : interference pair number$$

$$Δ {t}^{m} : difference in imaging dates$$

$$Δ {T}^{m} : difference in temperature z$$

$${{B}_{⊥}}^{m} : vertical baseline length of satellite$$

$$φ {res}^{m} : residual phase component$$

An optimal solution of the three unknown parameters v, k, and h is then estimated in such a way that the temporal coherence (TPC) γ is maximized, as indicated in the following Expression 3.

$$arg {max}_{v , k , h} \{ γ = \frac{1}{M} \vert {\sum }_{m = 1}^{M} exp \{ j \cdot {φ}_{res}^{m} \} \vert \} \qquad [ Expression 3 ]$$

As described above, the temporal coherence γ is an index representing smallness of dispersion of the residual phase component in the entire time-series phase difference data. The temporal coherence γ takes a value within a range of 0 to 1, and the closer to 1, the smaller the dispersion of the residual phase component. Therefore, in the bridge 30, the displacement is calculated using only measurement points at which the value of the temporal coherence γ is equal to or more than a set value.

Therefore, in the example of FIG. 3, measurement points having the low temporal coherence are not used for the calculation of the displacement. Therefore, the information processing apparatus 10 re-calculates parameters and residual phase components at the measurement points that cannot be used for the calculation of the displacement to appropriate values, in such a way that the measurement points that cannot be used for the calculation of the displacement can be used for the calculation of the displacement.

First, the similar component calculation unit 13 calculates the temporal coherence γ at each measurement point by using Expression 2 above, and selects the measurement points at which the temporal coherence γ is equal to or more than the set value as specific measurement points. The similar component calculation unit 13 further specifies equal to or more than two of the specific measurement points having a set positional relationship. Specifically, as illustrated in the example of FIG. 3, the similar component calculation unit 13 specifies equal to or more than two of the specific measurement points in a local region set on the bridge 30 in advance as being in a positional relationship set to be positioned in the local region.

The similar component calculation unit 13 then calculates weighted parameter averages (v-hat, k-hat, and h-hat) by averaging the parameters (v, k, and h) of equal to or more than two of the specific measurement points specified in the local region. Specifically, the similar component calculation unit 13 calculates the weighted parameter averages (v-hat, k-hat, and h-hat) by using the following Expressions 4 to 7. The number of specific measurement points specified in the local region is indicated by p.

$$\hat{v} = \frac{1}{P} {\sum }_{p = 1}^{P} {ω}_{p} {v}_{p} \qquad [ Expression 4 ]$$

$$\hat{k} = \frac{1}{P} {\sum }_{p = 1}^{P} {ω}_{p} {v}_{p} \qquad [ Expression 5 ]$$

$$\hat{h} = \frac{1}{P} {\sum }_{p = 1}^{P} {ω}_{p} {v}_{p} \qquad [ Expression 6 ]$$

$${ω}_{p} = \frac{{γ}_{p}}{{\sum }_{p = 1}^{P} {γ}_{p}} \qquad [ Expression 7 ]$$

The similar component calculation unit 13 also calculates a weighted residual average by averaging residual phase components φ^{m}ᵣₑₛ of equal to or more than two of the specific measurement points specified in the local region. Specifically, the similar component calculation unit 13 calculates the weighted residual average (φ^{m}ᵣₑₛ−hat) by using the following Expression 8. In the following Expression 8, j is an imaginary number.

$${\hat{φ}}_{res}^{m} = arg \{ {\sum }_{p = 1}^{P} exp \{ j {ω}_{p} {φ}_{res}^{m} \} \} \qquad [ Expression 8 ]$$

The estimation unit 14 estimates the weighted parameter averages (v-hat, k-hat, and h-hat) and the weighted residual average (φ^{m}ᵣₑₛ−hat) calculated as described above as the parameters (v, k, and h) and the residual phase components φ^{m}ᵣₑₛ of the unselected measurement points (the measurement points having the low temporal coherence). Hereinafter, the weighted parameter averages (v-hat, k-hat, and h-hat) are also referred to as “similarity parameters”. The weighted residual average is also referred to as a “similarity residual”.

For each unselected measurement point, the estimation unit 14 subtracts the similarity residual from an original phase difference φ_{diff} indicated in Expression 1 above, and sets the unknown parameters to the similarity parameters to newly obtain the residual phase component. The estimation unit 14 then newly obtains the temporal coherence γ for each unselected measurement point by using the newly obtained residual phase component. The estimation unit 14 can further calculate a difference between the newly obtained temporal coherence γ and the initial temporal coherence γ.

In a case where the calculated difference does not satisfy a condition, the estimation unit 14 adjusts the calculated similarity parameters and similarity residual. Examples of an adjustment method include increasing a numerical value by a set amount. The estimation unit 14 newly obtains the temporal coherence γ again by using the adjusted similarity parameters and similarity residual. In a case where the calculated difference satisfies the condition, the estimation unit 14 sets the similarity parameters and the similarity residual as the parameters and the residual phase components of the unselected measurement points. Examples of the condition for the difference include that “the difference is equal to or more than a threshold”.

The estimation unit 14 can set the calculated similarity parameters and similarity residual as initial values of Expression 1 above and re-estimate the three unknown parameters v, k, and h in both cases where the calculated difference satisfies the condition and does not satisfy the condition.

In a case where the calculated difference does not satisfy the condition, the unselected measurement points are considered not to have the same property as that of the selected specific measurement points, and therefore, the estimation unit 14 holds the values of the initial parameters and the residual phase components calculated for the unselected measurement points.

As illustrated in FIG. 4, the output unit 15 outputs, for each measurement point, position information, the time-series observation data (time-series phase difference data), a label indicating whether the residual phase component has been updated, the parameters, the similarity parameters, the similarity residual, and the value of the temporal coherence (TPC).

### [Apparatus Operation]

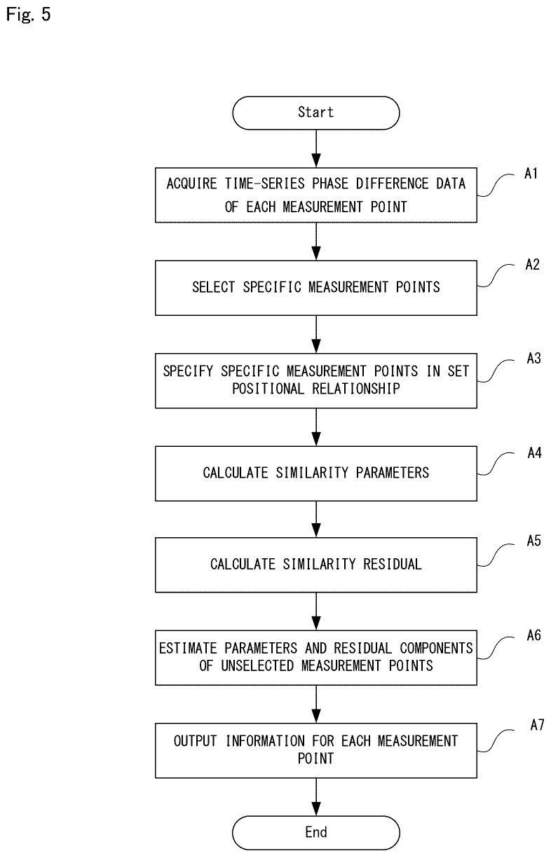

Next, operation of the information processing apparatus 10 will be described with reference to FIG. 5. FIG. 5 is a flowchart illustrating an example of the operation of the information processing apparatus. In the following description, FIGS. 1 to 4 will be appropriately referred to. In the example embodiment, the information processing method is performed by the information processing apparatus 10 being operated. Therefore, in the example embodiment, description of the information processing method is replaced with the following description of the operation of the information processing apparatus 10.

As illustrated in FIG. 5, in the example embodiment, the data acquisition unit 11 first acquires, from the database 21, time-series phase difference data at each of the measurement points 31 of the bridge 30 as time-series observation data for each measurement point (step A1).

Next, the similar component calculation unit 13 calculates the temporal coherence γ at each measurement point by using Expression 2 above, and selects measurement points at which the temporal coherence γ is equal to or more than a set value as specific measurement points (step A2).

Next, the similar component calculation unit 13 specifies equal to or more than two of the specific measurement points having a set positional relationship (step A3).

Next, the similar component calculation unit 13 calculates similarity parameters, in other words, weighted parameter averages (v-hat, k-hat, and h-hat) by averaging parameters (v, k, and h) of the specific measurement points specified in step A3 (step A4).

The similar component calculation unit 13 further calculates a similarity residual, in other words, a weighted residual average by averaging the residual phase components φ^{m}ᵣₑₛ of the specific measurement points specified in step A3 (step A5).

Next, the estimation unit 14 estimates the similarity parameters calculated in step A4 and the similarity residual calculated in step A5 as the parameters (v, k, h) and the residual phase components φ^{m}ᵣₑₛ of measurement points that are unselected in step A2 (step A6).

Thereafter, as illustrated in FIG. 4, the output unit 15 outputs various types of information for each measurement point, specifically, position information, time-series phase difference data, a label, the parameters, the similarity parameters, the similarity residual, and a value of the temporal coherence (TPC) (step A7).

### Effect of Example Embodiment

In this manner, in the example embodiment, the parameters and the residual phase components of the measurement points that cannot be used for the displacement analysis can be re-calculated to the appropriate values. Therefore, according to the example embodiment, it is possible to increase the number of available measurement points in a case where the displacement analysis of the structure is performed by the emission of the radio waves from above.

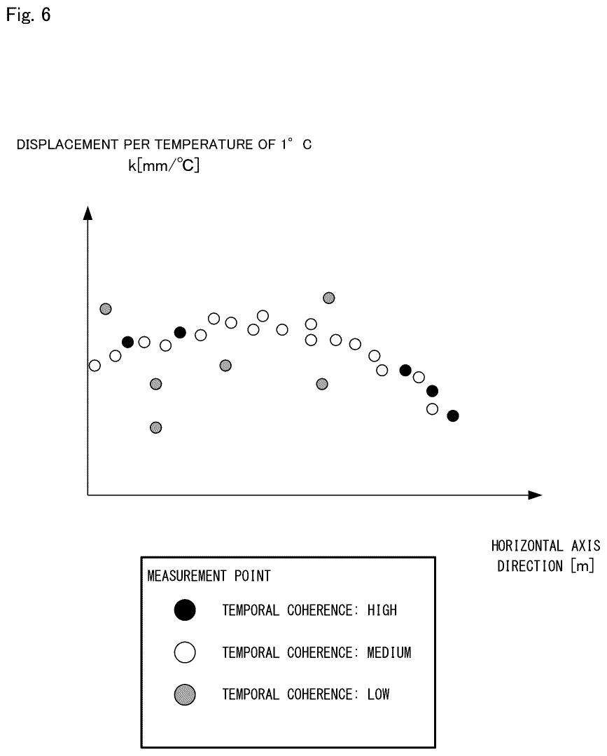

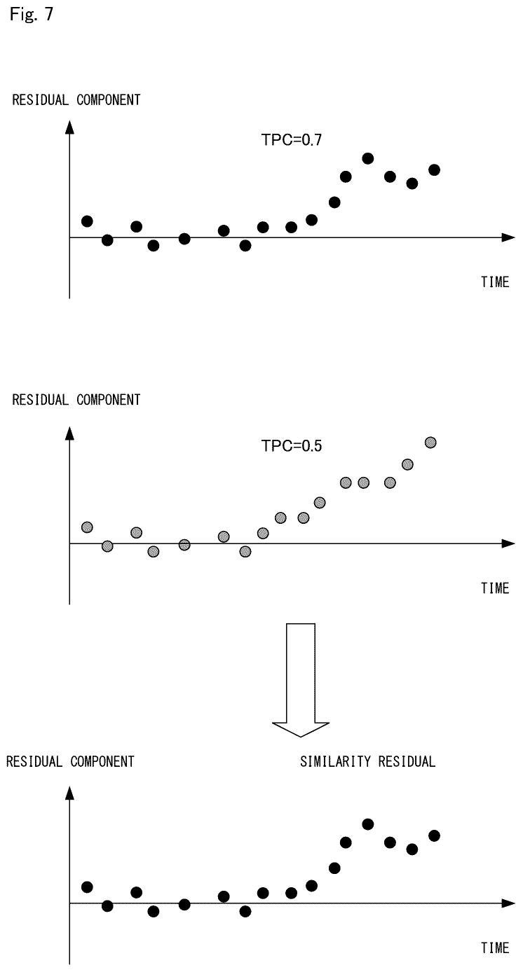

Here, the effect of the example embodiment will be described in more detail with reference to FIGS. 6 and 7. FIG. 6 is a diagram illustrating the parameter k for each measurement point. FIG. 7 is a diagram illustrating a relationship between the value of the temporal coherence and the residual phase component.

As illustrated in FIG. 6, in one section of the bridge 30, the parameter k has a property of being smoothly continuous in the bridge axis direction. On the other hand, the parameter k of the measurement point at which the value of the temporal coherence γ is low is a greatly deviated value. However, according to the example embodiment, the parameter k of the measurement point at which the value of the temporal coherence γ is low is a continuous value.

As illustrated in FIG. 7, the residual phase component of the measurement point at which the value of the temporal coherence γ is low changes differently from the residual phase component of the measurement point at which the value of the temporal coherence γ is high. However, according to the example embodiment, the change in the residual phase component of the measurement point at which the value of the temporal coherence γ is low is corrected.

Therefore, as illustrated in FIGS. 6 and 7, according to the example embodiment, the number of measurement points available for the displacement analysis can be increased. In the examples of FIGS. 6 and 7, the parameter k is described as an example, but the example embodiment is not limited to this. The same applies to the parameters v and h.

### [Modifications]

Hereinafter, modifications of the example embodiment will be described.

### First Modification:

In the example described above, the similar component calculation unit 13 specifies equal to or more than two of the specific measurement points having the set positional relationship. However, in a case where equal to or more than two of the specific measurement points having the set positional relationship do not exist, the similar component calculation unit 13 may specify only one specific measurement point. In this case, the similar component calculation unit 13 sets parameters of the one specific measurement point as the similarity parameters. The similar component calculation unit further sets a residual phase component of the one specific measurement point as the similarity residual.

### Second Modification:

The similar component calculation unit 13 can interpolate each of the parameters and the residual phase components for a part of the unselected measurement points, and can also select the interpolated measurement points as the specific measurement points. Specifically, the similar component calculation unit 13 can determine the parameters of the unselected measurement points based on a tendency of the parameters illustrated in FIG. 6. The similar component calculation unit 13 can also determine the residual phase components of the unselected measurement points by using a tendency of the change in the residual phase component of the measurement point at which the value of the temporal coherence γ is high illustrated in FIG. 7.

### [Program]

In the example embodiment, it is sufficient that the program is a program that causes a computer to execute steps A1 to A7 illustrated in FIG. 5. By installing the program in the computer and executing the program, the information processing apparatus 10 and the information processing method can be achieved. In this case, a processor of the computer functions as the data acquisition unit 11, the calculation processing unit 12, and the output unit 15, and performs processing. Examples of the computer include a smartphone and a tablet terminal device in addition to a general-purpose PC and a server device.

In the example embodiment, the program may be executed by a computer system constructed by a plurality of computers. In this case, for example, each computer may function as any one of the data acquisition unit 11, the calculation processing unit 12, and the output unit 15.

### [Physical Configuration]

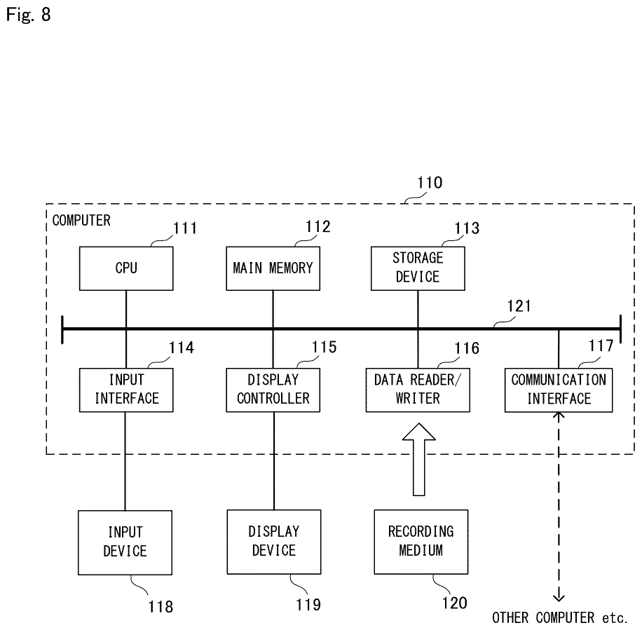

Here, the computer that achieves the information processing apparatus 10 by executing the program in the example embodiment will be described with reference to FIG. 8. FIG. 8 is a block diagram illustrating an example of the computer that achieves the information processing apparatus.

As illustrated in FIG. 8, a computer 110 includes a central processing unit (CPU) 111, a main memory 112, a storage device 113, an input interface 114, a display controller 115, a data reader/writer 116, and a communication interface 117. These units are data-communicably connected to each other via a bus 121.

The computer 110 may include a graphics processing unit (GPU), an application specific integrated circuit (ASIC), or a field-programmable gate array (FPGA), in addition to the CPU 111 or instead of the CPU 111. In this aspect, the GPU, the ASIC, or the FPGA can execute the program in the example embodiment.

The CPU 111 loads the program in the example embodiment, which is stored in the storage device 113 and configured by codes, to the main memory 112, and executes each code in predetermined order to perform various operations. The main memory 112 is typically a volatile storage device such as a dynamic random access memory (DRAM).

The program in the example embodiment is provided in a state of being stored in a computer-readable recording medium 120. The program in the present example embodiment may be distributed on the Internet connected via the communication interface 117.

Specific examples of the storage device 113 include a semiconductor storage device such as a flash memory in addition to a hard disk drive. The input interface 114 mediates data transmission between the CPU 111 and an input device 118 such as a keyboard and a mouse. The display controller 115 is connected to a display device 119, and controls display on the display device 119.

The data reader/writer 116 mediates data transmission between the CPU 111 and the recording medium 120, and reads the program from the recording medium 120 and writes a processing result in the computer 110 into the recording medium 120. The communication interface 117 mediates data transmission between the CPU 111 and another computer.

Specific examples of the recording medium 120 include general-purpose semiconductor storage devices such as Compact Flash (CF) (registered trademark) and a secure digital (SD), a magnetic recording medium such as a flexible disk, and an optical recording medium such as a compact disk read only memory (CD-ROM).

The information processing apparatus 10 may also be achieved by using hardware related to each unit, for example, an electronic circuit, instead of the computer in which the program is installed. A part of the information processing apparatus 10 may be achieved by the program, and the remaining part may be achieved by the hardware. In the example embodiment, the computer is not limited to the computer illustrated in FIG. 8.

A part or all of the example embodiment described above may be expressed as, but is not limited to, the following (Supplementary Note 1) to (Supplementary Note 18).

### (Supplementary Note 1)

An information processing apparatus including:
a data acquisition unit that acquires time-series observation data for each measurement point of an object, the time-series observation data being generated by emission of radio waves from a flying object to the object; and
a calculation processing unit that selects a specific measurement point by using temporal coherence used for estimation of a parameter for modeling the observation data for each measurement point, and calculates the parameter and a residual phase component of an unselected measurement point by using the parameter and the residual phase component generated at the time of the modeling at the selected specific measurement point.

### (Supplementary Note 2)

The information processing apparatus according to Supplementary Note 1, in which
the calculation processing unit calculates a similarity parameter from one or more of the specific measurement points, and calculates a similarity residual by using the residual phase component of the specific measurement point,
sets the similarity parameter as the parameter of the unselected measurement point, and
sets the similarity residual as the residual phase component of the unselected measurement point.

### (Supplementary Note 3)

The information processing apparatus according to Supplementary Note 2, in which
the calculation processing unit calculates a weighted parameter average as the similarity parameter by averaging the parameters of equal to or more than two of the specific measurement points having a set positional relationship, and
calculates a weighted residual average as the similarity residual by averaging the residual phase components of the equal to or more than two specific measurement points.

### (Supplementary Note 4)

The information processing apparatus according to Supplementary Note 2, in which,
for each unselected measurement point,
the calculation processing unit
newly obtains the temporal coherence by using the similarity parameter and the similarity residual, and calculates a difference between the newly obtained temporal coherence and the initial temporal coherence,
adjusts the similarity parameter and the similarity residual in a case where the calculated difference does not satisfy a condition, and newly obtains the temporal coherence again by using the adjusted similarity parameter and the adjusted similarity residual, and
sets the similarity parameter and the similarity residual as the parameter and the residual phase component of the measurement point in a case where the calculated difference satisfies the condition.

### (Supplementary Note 5)

The information processing apparatus according to Supplementary Note 1, in which
the calculation processing unit interpolates each of the parameter and the residual phase component for a part of the unselected measurement points, and also selects the interpolated measurement point as the specific measurement point.

### (Supplementary Note 6)

The information processing apparatus according to Supplementary Note 1, in which
the object is an infrastructure,
the parameter includes at least a parameter proportional to displacement due to a temperature and a parameter proportional to displacement due to a time, and
the temporal coherence is calculated in such a way that the parameter is optimized and dispersion of the residual phase component is minimized.

### (Supplementary Note 7)

An information processing method including:
a data acquisition step of acquiring time-series observation data for each measurement point of an object, the time-series observation data being generated by emission of radio waves from a flying object to the object; and
a calculation processing step of selecting a specific measurement point by using temporal coherence used for estimation of a parameter for modeling the observation data for each measurement point, and calculating the parameter and a residual phase component of an unselected measurement point by using the parameter and the residual phase component generated at the time of the modeling at the selected specific measurement point.

### (Supplementary Note 8)

The information processing method according to Supplementary Note 7, in which,
in the calculation processing step, a similarity parameter is calculated from one or more of the specific measurement points, and a similarity residual is calculated by using the residual phase component of the specific measurement point,
the similarity parameter is set as the parameter of the unselected measurement point, and
the similarity residual is set as the residual phase component of the unselected measurement point.

### (Supplementary Note 9)

The information processing method according to Supplementary Note 8, in which,
in the calculation processing step, a weighted parameter average is calculated as the similarity parameter by averaging the parameters of equal to or more than two of the specific measurement points having a set positional relationship, and
a weighted residual average is calculated as the similarity residual by averaging the residual phase components of the equal to or more than two specific measurement points.

### (Supplementary Note 10)

The information processing method according to Supplementary Note 8, in which,
in the calculation processing step,
for each unselected measurement point,
the temporal coherence is newly obtained by using the similarity parameter and the similarity residual, and a difference between the newly obtained temporal coherence and the initial temporal coherence is calculated,
the similarity parameter and the similarity residual are adjusted in a case where the calculated difference does not satisfy a condition, and the temporal coherence is newly obtained again by using the adjusted similarity parameter and the adjusted similarity residual, and
the similarity parameter and the similarity residual are set as the parameter and the residual phase component of the measurement point in a case where the calculated difference satisfies the condition.

### (Supplementary Note 11)

The information processing method according to Supplementary Note 7, in which,
in the calculation processing step, each of the parameter and the residual phase component is interpolated for a part of the unselected measurement points, and the interpolated measurement point is also selected as the specific measurement point.

### (Supplementary Note 12)

The information processing method according to Supplementary Note 7, in which
the object is an infrastructure,
the parameter includes at least a parameter proportional to displacement due to a temperature and a parameter proportional to displacement due to a time, and
the temporal coherence is calculated in such a way that the parameter is optimized and dispersion of the residual phase component is minimized.

### (Supplementary Note 13)

A computer-readable recording medium recording a program including a command for causing a computer to execute:
a data acquisition step of acquiring time-series observation data for each measurement point of an object, the time-series observation data being generated by emission of radio waves from a flying object to the object; and
a calculation processing step of selecting a specific measurement point by using temporal coherence used for estimation of a parameter for modeling the observation data for each measurement point, and calculating the parameter and a residual phase component of an unselected measurement point by using the parameter and the residual phase component generated at the time of the modeling at the selected specific measurement point.

### (Supplementary Note 14)

The computer-readable recording medium according to Supplementary Note 13, in which,
in the calculation processing step, a similarity parameter is calculated from one or more of the specific measurement points, and a similarity residual is calculated by using the residual phase component of the specific measurement point,
the similarity parameter is set as the parameter of the unselected measurement point, and
the similarity residual is set as the residual phase component of the unselected measurement point.

### (Supplementary Note 15)

The computer-readable recording medium according to Supplementary Note 14, in which,
in the calculation processing step, a weighted parameter average is calculated as the similarity parameter by averaging the parameters of equal to or more than two of the specific measurement points having a set positional relationship, and
a weighted residual average is calculated as the similarity residual by averaging the residual phase components of the equal to or more than two specific measurement points.

### (Supplementary Note 16)

The computer-readable recording medium according to Supplementary Note 14, in which,
in the calculation processing step,
for each unselected measurement point,
the temporal coherence is newly obtained by using the similarity parameter and the similarity residual, and a difference between the newly obtained temporal coherence and the initial temporal coherence is calculated,
the similarity parameter and the similarity residual are adjusted in a case where the calculated difference does not satisfy a condition, and the temporal coherence is newly obtained again by using the adjusted similarity parameter and the adjusted similarity residual, and
the similarity parameter and the similarity residual are set as the parameter and the residual phase component of the measurement point in a case where the calculated difference satisfies the condition.

### (Supplementary Note 17)

The computer-readable recording medium according to Supplementary Note 13, in which,
in the calculation processing step, each of the parameter and the residual phase component is interpolated for a part of the unselected measurement points, and the interpolated measurement point is also selected as the specific measurement point.

### (Supplementary Note 18)

The computer-readable recording medium according to Supplementary Note 13, in which
the object is an infrastructure,
the parameter includes at least a parameter proportional to displacement due to a temperature and a parameter proportional to displacement due to a time, and
the temporal coherence is calculated in such a way that the parameter is optimized and dispersion of the residual phase component is minimized.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

As described above, according to the present disclosure, it is possible to increase the number of available measurement points in a case where displacement analysis of a structure is performed by emission of radio waves from above. The present disclosure is useful in, for example, a system that analyzes an infrastructure.

1. An information processing apparatus comprising:
at least one memory storing instructions; and
at least one processor configured to execute the instructions to:
acquire time-series observation data for each measurement point of an object, the time-series observation data being generated by emission of radio waves from a flying object to the object; and
select a specific measurement point by using temporal coherence used for estimation of a parameter for modeling the observation data for each measurement point, and calculate the parameter and a residual phase component of an unselected measurement point by using the parameter and the residual phase component generated at the time of the modeling at the selected specific measurement point.

2. The information processing apparatus according to claim 1, wherein
at least one processor calculates a similarity parameter from one or more of the specific measurement points, and calculates a similarity residual by using the residual phase component of the specific measurement point,
sets the similarity parameter as the parameter of the unselected measurement point, and
sets the similarity residual as the residual phase component of the unselected measurement point.

3. The information processing apparatus according to claim 2, wherein
at least one processor calculates a weighted parameter average as the similarity parameter by averaging the parameters of equal to or more than two of the specific measurement points having a set positional relationship, and
calculates a weighted residual average as the similarity residual by averaging the residual phase components of the equal to or more than two specific measurement points.

4. The information processing apparatus according to claim 2, wherein,
for each unselected measurement point,
at least one processor
newly obtains the temporal coherence by using the similarity parameter and the similarity residual, and calculates a difference between the newly obtained temporal coherence and the initial temporal coherence,
adjusts the similarity parameter and the similarity residual in a case where the calculated difference does not satisfy a condition, and newly obtains the temporal coherence again by using the adjusted similarity parameter and the adjusted similarity residual, and
sets the similarity parameter and the similarity residual as the parameter and the residual phase component of the measurement point in a case where the calculated difference satisfies the condition.

5. The information processing apparatus according to claim 1, wherein
at least one processor interpolates each of the parameter and the residual phase component for a part of the unselected measurement points, and also selects the interpolated measurement point as the specific measurement point.

6. The information processing apparatus according to claim 1, wherein
the object is an infrastructure,
the parameter includes at least a parameter proportional to displacement due to a temperature and a parameter proportional to displacement due to a time, and
the temporal coherence is calculated in such a way that the parameter is optimized and dispersion of the residual phase component is minimized.

7. An information processing method comprising:
acquiring time-series observation data for each measurement point of an object, the time-series observation data being generated by emission of radio waves from a flying object to the object; and
selecting a specific measurement point by using temporal coherence used for estimation of a parameter for modeling the observation data for each measurement point, and calculating the parameter and a residual phase component of an unselected measurement point by using the parameter and the residual phase component generated at the time of the modeling at the selected specific measurement point.

8. The information processing method according to claim 7, wherein,
in the calculation processing, a similarity parameter is calculated from one or more of the specific measurement points, and a similarity residual is calculated by using the residual phase component of the specific measurement point,
the similarity parameter is set as the parameter of the unselected measurement point, and
the similarity residual is set as the residual phase component of the unselected measurement point.

9. The information processing method according to claim 8, wherein,
in the calculation processing, a weighted parameter average is calculated as the similarity parameter by averaging the parameters of equal to or more than two of the specific measurement points having a set positional relationship, and
a weighted residual average is calculated as the similarity residual by averaging the residual phase components of the equal to or more than two specific measurement points.

10. The information processing method according to claim 8, wherein,
for each unselected measurement point,
in the calculation processing,
the temporal coherence is newly obtained by using the similarity parameter and the similarity residual, and a difference between the newly obtained temporal coherence and the initial temporal coherence is calculated,
the similarity parameter and the similarity residual are adjusted in a case where the calculated difference does not satisfy a condition, and the temporal coherence is newly obtained again by using the adjusted similarity parameter and the adjusted similarity residual, and
the similarity parameter and the similarity residual are set as the parameter and the residual phase component of the measurement point in a case where the calculated difference satisfies the condition.

11. The information processing method according to claim 7, wherein,
in the calculation processing, each of the parameter and the residual phase component is interpolated for a part of the unselected measurement points, and the interpolated measurement point is also selected as the specific measurement point.

12. The information processing method according to claim 7, wherein
the object is an infrastructure,
the parameter includes at least a parameter proportional to displacement due to a temperature and a parameter proportional to displacement due to a time, and
the temporal coherence is calculated in such a way that the parameter is optimized and dispersion of the residual phase component is minimized.

13. A non-transitory computer-readable recording medium recording a program for causing a computer to:
acquire time-series observation data for each measurement point of an object, the time-series observation data being generated by emission of radio waves from a flying object to the object; and
select a specific measurement point by using temporal coherence used for estimation of a parameter for modeling the observation data for each measurement point, and calculate the parameter and a residual phase component of an unselected measurement point by using the parameter and the residual phase component generated at the time of the modeling at the selected specific measurement point.

14. The non-transitory computer-readable recording medium according to claim 13, wherein
the program further causes the computer to:
in the calculation processing, calculate a similarity parameter from one or more of the specific measurement points, and calculate a similarity residual by using the residual phase component of the specific measurement point;
set the similarity parameter as the parameter of the unselected measurement point; and
set the similarity residual as the residual phase component of the unselected measurement point.

15. The non-transitory computer-readable recording medium according to claim 14, wherein
the program further causes the computer to:
in the calculation processing, calculate a weighted parameter average as the similarity parameter by averaging the parameters of equal to or more than two of the specific measurement points having a set positional relationship; and
calculate a weighted residual average as the similarity residual by averaging the residual phase components of the equal to or more than two specific measurement points.

16. The non-transitory computer-readable recording medium according to claim 14, wherein
the program further causes the computer to:
in the calculation processing,
for each unselected measurement point,
newly obtain the temporal coherence by using the similarity parameter and the similarity residual, and calculate a difference between the newly obtained temporal coherence and the initial temporal coherence;
adjust the similarity parameter and the similarity residual in a case where the calculated difference does not satisfy a condition, and newly obtain the temporal coherence again by using the adjusted similarity parameter and the adjusted similarity residual; and
set the similarity parameter and the similarity residual as the parameter and the residual phase component of the measurement point in a case where the calculated difference satisfies the condition.

17. The non-transitory computer-readable recording medium according to claim 13, wherein
the program further causes the computer to,
in the calculation processing, interpolate each of the parameter and the residual phase component for a part of the unselected measurement points, and also select the interpolated measurement point as the specific measurement point.

18. The non-transitory computer-readable recording medium according to claim 13, wherein
the object is an infrastructure,
the parameter includes at least a parameter proportional to displacement due to a temperature and a parameter proportional to displacement due to a time, and
the temporal coherence is calculated in such a way that the parameter is optimized and dispersion of the residual phase component is minimized.
